(19) United States
(12) Patent Application Publication
(10) Pub. No.: US 2018/0149278 A1
(43) Pub. Date: May 31, 2018

(54) TORQUE REDUCING VALVE SEAT

(71) Applicant: Mueller International, LLC, Atlanta, GA (US)

(72) Inventors: Ashraf Abouelleil, Oswego, IL (US); Purushottam Savalia, Aurora, IL (US); Robert Newkirk, Dixon, IL (US)

(21) Appl. No.: 15/363,410

(22) Filed: Nov. 29, 2016

(51) Int. Cl. F16K 25/00; F16K 1/226; B23P 15/00

(52) U.S. Cl. CPC F16K 25/005; B23P 15/001; F16K 1/226

(57) ABSTRACT

A valve seat includes an annular sealing surface comprising a rubber-lubricant mixture; and a seat body. A valve includes a valve body; a valve element disposed within the valve body; and a valve seat comprising a rubber-lubricant mixture, the valve element configured to seal against the valve seat. A method for forming a valve seat includes mixing a raw rubber with a lubricant to form a rubber-lubricant mixture; placing the rubber-lubricant mixture into a mold configured to form a valve seat; and curing the rubber-lubricant mixture.

### TECHNICAL FIELD

This disclosure relates to valve assemblies. More specifically, this disclosure relates to valve seats.

### BACKGROUND

Valves and valve assemblies can be used for controlling or regulating the flow of a fluid, such as water, oil, or gas, through a passageway such as a piping system. Valves assemblies can comprise a valve body which can define a bore, a valve element positioned within the bore, and a valve seat positioned within the valve body. A butterfly valve is a type of valve in which the valve element can be a disc. The valve element can be configured to seal against the valve seat in order to prevent the flow of fluid through the bore when the valve element is in a closed position or to allow the flow of fluid through the bore when the valve element is in a partially-open position or fully open position. The valve element can be actuated about and between the closed position and the open position by applying a torque to a stem connected to the valve element. The torque required to actuate the valve can increase as the diameter of the bore increases or as a pressure differential across the valve element in the closed position increases. Increasing the torque required to actuate the valve can require larger, heavier, and more expensive actuators which can be undesirable in some applications.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

Disclosed is a valve seat comprising an annular sealing surface comprising a rubber-lubricant mixture; and a seat body. Also disclosed is a valve comprising a valve body; a valve element disposed within the valve body; and a valve seat comprising a rubber-lubricant mixture, the valve element configured to seal against the valve seat. Also disclosed is a method for forming a valve seat comprising mixing a raw rubber with a lubricant to form a rubber-lubricant mixture; placing the rubber-lubricant mixture into a mold configured to form a valve seat; and curing the rubber-lubricant mixture.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

The features and components of the following figures are illustrated to emphasize the general principles of the present disclosure. The drawings are not necessarily drawn to scale. Corresponding features and components throughout the figures may be designated by matching reference characters for the sake of consistency and clarity.

FIG. 1 is a perspective view of a valve assembly with a disc in a closed position in accordance with one aspect of the disclosure.

FIG. 2 is a perspective view of another aspect of a valve of the valve assembly of FIG. 1 with the disc in an open position.

FIG. 3 is an exploded view of the valve of FIG. 2.

FIG. 4 is a perspective view of a valve seat of the valve of FIG. 2.

FIG. 5 is a front view of the valve seat of FIG. 4.

FIG. 6 is a cross-section of the valve of FIG. 2 demonstrating the disc seating against the valve seat and taken along line 6-6 in FIG. 2.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element” can include two or more such element unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

In one aspect, disclosed is a valve seat comprising an annular sealing surface and a seat body comprising a rubber-lubricant mixture. It would be understood by one of skill in the art that the disclosed valve seat is described in but a few exemplary aspects among many. No particular terminology or description should be considered limiting on the disclosure or the scope of any claims issuing therefrom.

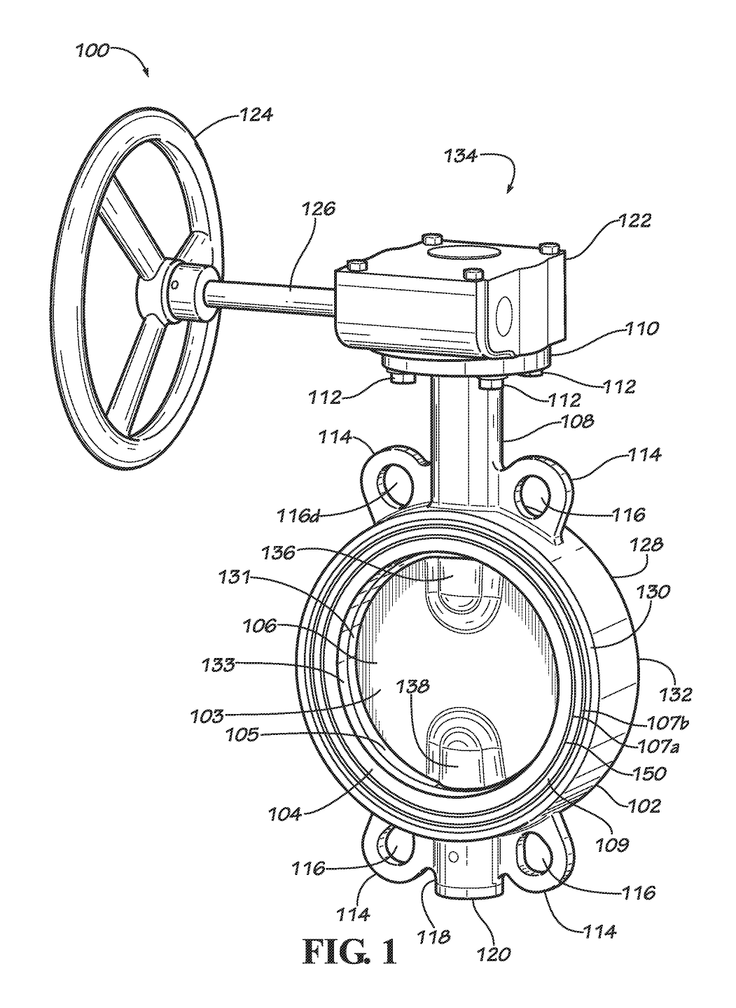

FIG. 1 shows a perspective view of a valve assembly 100 in accordance with one aspect of the disclosure. The valve assembly 100 can comprise a valve 101 and an actuator 134. The valve 101 can comprise a body 102, a valve seat 104, and a valve element 103. The valve element 103 can be disposed within the valve body 102, and the valve element 103 can be configured to seal against the valve seat 104. The valve element 103 in FIG. 1 is shown in a closed position. In the aspect shown, the valve 101 can be a butterfly valve, and the valve element 103 can be a disc 106. In other aspects, the valve 101 can be a different type of valve such as a gate valve, ball valve, or other suitable valve, and the valve element 103 can be a gate, a ball, a plug, or another type of valve element. In various aspects, the disc 106 can be constructed from stainless steel; however, in other aspects, the disc 106 can be made from coated ductile iron, aluminum, bronze, plastic, or any other similar material. Additionally, the disc 106 can comprise any desirable coating such as Nylon 11, nickel-phosphorus or nickel-boron alloy applied through electroless nickel plating (ENP plating), or any other suitable coating.

The body 102 can comprise a one-piece construction made from ductile iron. In other aspects, the body 102 can be made from cast iron, cast bronze, stainless steel, carbon steel, aluminum, plastic, or any other suitable material. Additionally, in various other aspects, the body 102 can comprise a multiple-piece construction with various components attached together to create the body 102.

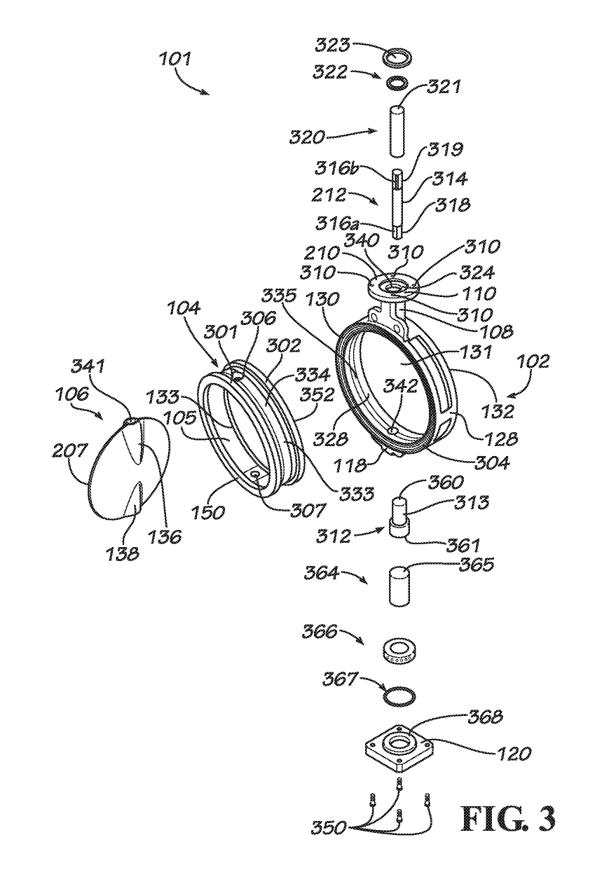

In various aspects, the body 102 and the valve seat 104 can each define a substantially annular or tubular shape; however, the body 102 and valve seat 104 can define other shapes such as a rectangular shape in other aspects. The body 102 can comprise a first body end 130 and a second body end 132 distal from the first body end 130. The valve seat 104 can comprise a first seat end 150 and a second seat end 352 (shown in FIG. 3) distal from the first seat end 150. The first seat end 150 can be positioned proximate the first body end 130, and the second seat end 352 can be positioned proximate the second body end 132. The body 102 and the valve seat 104 can define a bore 131 extending through the body 102 and the valve seat 104 from the first ends 130,150 to the second ends 132,352. The bore 131 can define a bore axis therethrough.

The bore 131 can define an inner seat surface 133 of the valve seat 104 which faces radially inwards towards the valve element 103. The inner seat surface 133 extends from the first seat end 150 to the second seat end 352. The valve seat can also define an outer seat surface 333 (shown in FIG. 3) opposite from the inner seat surface 133. The outer seat surface 333 faces radially outwards towards an inner body surface 328 (shown in FIG. 3) defined by the body 102. The inner body surface 328 extends from the first body end 130 to the second body end 132. The body 102 defines an body outer surface 128 positioned opposite from the inner body surface 328 which faces outwards from the body 102. The outer seat surface 333 can be positioned in contact with the inner body surface 328 with the valve seat 104 positioned between the body 102 and the valve element 103. The contact between the outer seat surface 333 and the inner body surface 328 can provide a seal between the valve seat 104 and the body 102.

In various aspects, the body 102 can comprise an upper neck 108 extending radially outwards from the body outer surface 128. The body 102 can also comprise a lower neck 118 extending radially outwards from the body outer surface 128. In various aspects, the lower neck 118 extends radially outwards from the body outer surface 128 at a location on the body outer surface 128 opposite from the location of the upper neck 108 on the body outer surface 128. The upper neck 108 and lower neck 118 can each define a substantially annular or tubular shape with a shaft axis perpendicular to the bore axis of the body 102; however, the upper neck 108 and lower neck 118 can define other shapes in various other aspects.

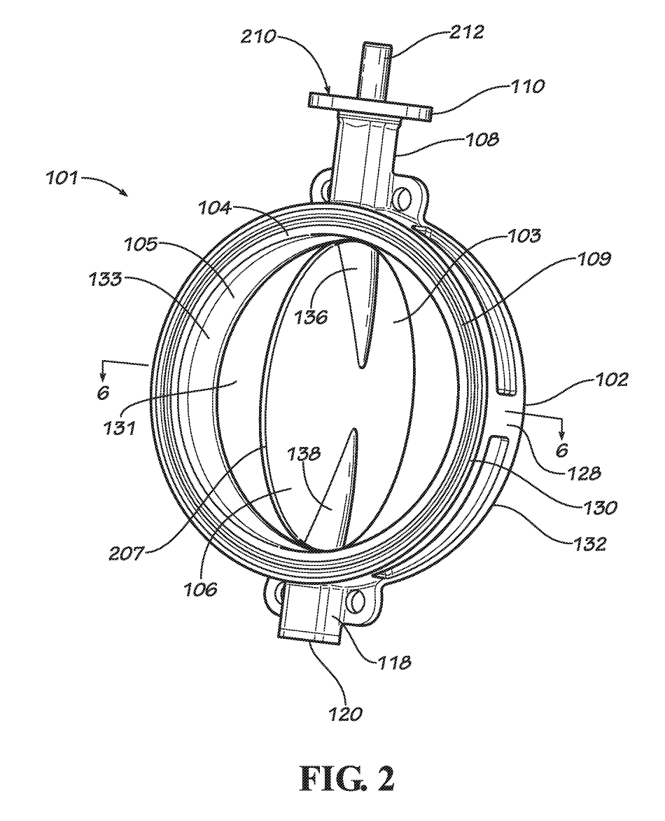

In various aspects, a bottom cap 120 can be attached to the lower neck 118 and can seal the lower neck 118 from the outside environment. In some aspects, the upper neck 108 can also comprise a top flange 110. In these aspects, the top flange 110 can be at an end of the upper neck 108 distal from the body outer surface 128. The top flange 110 can provide a location and a mechanism to attach the actuator 134 to the valve assembly 100. In various applications, the actuator 134 is configured to selectively move the valve element 103 through a range of positions about and between an open position and a closed position. In the closed position, the valve element 103 is positioned to seal against the valve seat 104 to prevent the flow of fluid through the valve 101. In the open position shown in FIG. 2, the valve element 103 is positioned to allow maximum flow through the valve 101. In applications in which the valve assembly 100 is used for throttling or flow-control, the valve element 103 can also be positioned in a partially-open position within the range of positions between the open position and the closed position in order to control a flowrate of fluid through the valve 101.

In the present aspect, the disc 106 can be rotated about the shaft axis about 90-degrees from the closed position to place the valve 101 in the open position. In the open position, the disc 106 obstructs a minimum portion of the bore 131 possible for a shape and a size of the bore 131 and the disc 106. In other aspects in which the valve 101 is a different type of valve such as a ball valve or a gate valve, the bore can be completely unobstructed by the valve element 103 in the open position. In some aspects, the valve element 103 can translate between the open position and the closed position rather than rotate.

In various aspects, the actuator 134 can be a manual actuator that comprises a handwheel 124, a gearbox 122, and a shaft 126 connecting the handwheel 124 to the gearbox 122. The gearbox 122 can be configured to multiply a torque applied to the handwheel 124 and transfer the multiplied torque to the valve element 103 to selectively move the valve element 103 through the range of positions about and between the open position and the closed position. The gearbox 122 of the actuator 134 can be secured to the top flange 110 of the valve 101 with fasteners 112. In the present aspect, the fasteners 112 are screws; however in some aspects, other suitable attachment mechanisms can be used. Although a manual actuator is shown in FIG. 1, in various other aspects, the actuator can be a pneumatic actuator, electric actuator, or any other desired actuator. In some aspects, the gearbox 122 can be mated to a solenoid motor or a stepper motor, and the valve assembly 100 can be a control valve assembly.

In the aspect shown, the valve 101 is a wafer-type valve configured to be installed between a pair of pipe flanges (not shown). In other aspects, the valve 101 can be configured as a lug-type valve or a double-flanged type valve. The body 102 can comprise alignment flanges 114 extending radially outwards from the body outer surface 128 and alignment holes 116 defined in the alignment flanges 114. In various aspects, the body 102 can comprise any number of alignment flanges 114 and any number alignment holes 116. In various aspects, long bolts or studs (not shown) can pass through the alignment holes 116 to position the valve assembly 100 between the pipe flanges. The valve assembly 100 can be compressed between the pipe flanges and held in place by the tensioned bolts or studs extending between the flanges. In some aspects such as the lug-type valve or the double-flanged type valve, the valve 101 can be bolted directly to each flange of the pair of flanges. In the present aspect, the body 102 comprises four alignment flanges 114 and four alignment holes 116; however, in various other aspects, any desired number of alignment flanges 114 and alignment holes 116 can be present.

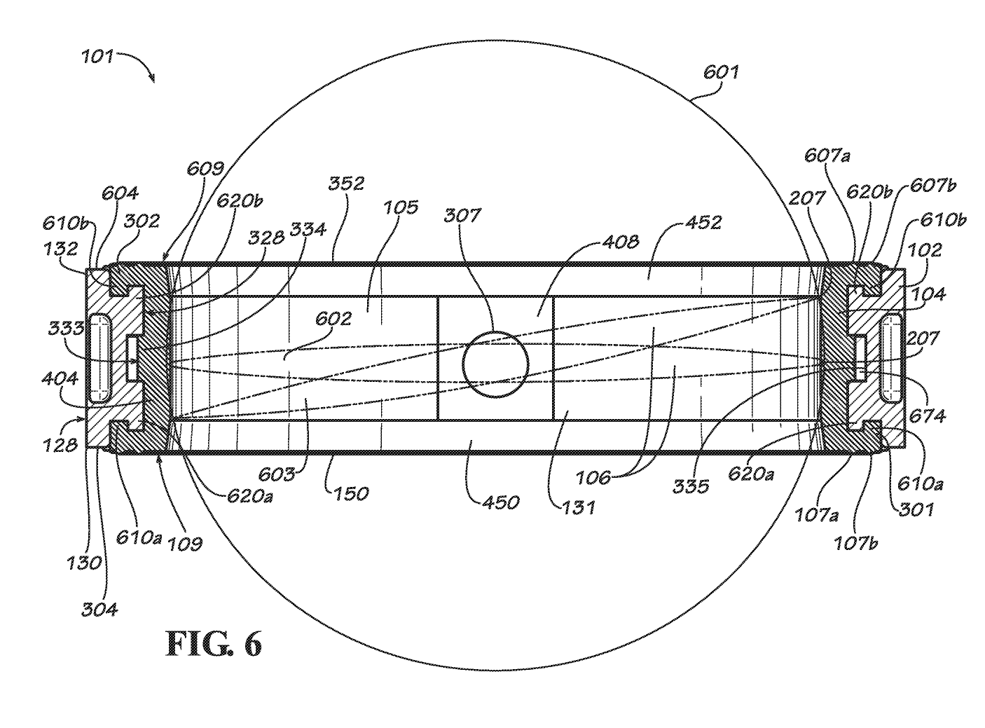

The first seat end 150 can define a first flange sealing surface 109, and the second seat end 352 can define a second flange sealing surface 609 (shown in FIG. 6) In the present aspect, the first flange sealing surface 109 can define a pair of first flange sealing ridges 107a,b, and the second flange sealing surface 609 can define a pair of second flange sealing ridges 607a,b (shown in FIG. 6). The flange sealing surfaces 109,609 and the flange sealing ridges 107,607 can each be configured to seal against a flange face of the pair of pipe flanges when the valve 101 is installed between the pipe flanges.

In the present aspect, the disc 106 can define a substantially circular shape. In the present aspect, the disc 106 can define an upper shaft receiving portion 136 and a lower shaft receiving portion 138. In these aspects, the valve 101 can comprise an upper shaft 212 (shown in FIG. 2) inserted through the upper neck 108 and valve seat 104 and into the upper shaft receiving portion 136. The valve 101 can also comprise a lower shaft 312 (shown in FIG. 3) inserted through the lower neck 118 and valve seat 104 and into the lower shaft receiving portion 138. In these aspects, the upper shaft 212 and the lower shaft 312 can rotably secure the disc 106 within the bore 131. In some aspects, the valve 101 can comprise only a single stem.

As previously described, the valve element 103 can be positioned within the bore 131 defined by the body 102 and the valve seat 104. A portion of the inner seat surface 133 of the valve seat 104 can define an annular sealing surface 105 configured to form a seal against the valve element 103 in the closed position shown in FIG. 1. In the present aspect, the annular sealing surface 105 can form the seal against a perimeter 207 (shown in FIG. 2) of the disc 106. Additionally, in various aspects, when the outer seat surface 333 of the valve seat 104 mates with the inner body surface 328 of the body 102, a seal can be formed between the valve seat 104 and body 102. This seal can be formed around the entire inner body surface 328 of the body 102. In various aspects, when the valve 101 is in the closed position, the seal between the valve seat 104 and the body 102 and the seal between the valve seat 104 and the valve element 103 can prevent the flow of fluid through the valve 101.

The valve seat 104 can be constructed from a single or continuous piece of material. In various aspects, the valve seat 104 can be constructed from a deformable material. In the present aspect, the valve seat 104 can comprise a rubber-lubricant mixture which is described in further detail below.

FIG. 2 shows another aspect of the valve 101 of the valve assembly 100 with the actuator 134 removed. The valve 101 of the present aspect is substantially similar to the valve 101 of the aspect of FIG. 1. The top flange 110 can define a mounting surface 210 configured to seal against an actuator 134 or a cover (not shown). The upper shaft 212 can protrude through the upper neck 108. In some applications such as for small diameter valves where torque multiplication provided by the gearbox 122 is not desired, a handwheel, lever, or other manual action mechanism can be attached directly to the upper shaft 212 in order to actuate the valve element 103, and the mounting surface 210 can be sealed by the cover (not shown) to prevent debris from entering the body 102. In the aspect shown, the disc 106 is in the open position allowing fluid to flow through the bore 131. The disc 106 is positioned rotated approximately 90-degrees about the shaft axis from the closed position shown in FIG. 1. In the open position, the perimeter 207 of the disc 106 is in minimal contact with the annular sealing surface 105, primarily proximate the upper shaft receiving portion 136 and the lower shaft receiving portion 138.

FIG. 3 shows an exploded view of the valve 101. In the present aspect, the valve seat 104 can be removed from the body 102. In some aspects, the valve seat 104 can be permanently epoxied, bonded, or glued to the body 102. The outer seat surface 333 can define a seat tongue 334 which can be shaped and sized complimentary to a groove 335 defined by the inner body surface 328. The seat tongue 334 can extend radially outward from the valve seat 104. The groove 335 can be configured to receive the seat tongue 334 when the valve seat 104 is installed within the body 102. The interface between the seat tongue 334 and the groove 335 can retain the valve seat 104 in body 102 and resist movement of the valve seat 104 relative to the body 102 when the disc 106 is rotated. In some aspects, a gap 674 can be defined between the seat tongue 334 and the groove 335 as shown in FIG. 6. A valve body and seat defining a gap between a tongue and a groove are further described in U.S. patent application Ser. No. 14/573,287, filed Dec. 17, 2014, and published Jun. 23, 2016 in U.S. Publication Number 2016-0178067 A1, which is incorporated by reference herein.

The valve seat 104 can also comprise a first lip 301 disposed at the first seat end 150 and a second lip 302 disposed as the second seat end 352. The first lip 301 can be configured to cover a portion of a first body face 304 defined at the first body end 130 of the body 102 when the valve seat 104 is installed within the body 102. The second lip 302 can be configured to cover a portion of a second body face 604 (shown in FIG. 6) defined at the second body end 132 of the body 102 when the valve seat 104 is installed within the body 102. The lips 301,302 can retain the valve seat 104 within the body 102, protect the body faces 304,604, and seal against the pair of flanges when the valve 101 is installed between two pipes.

The valve seat 104 can define a upper seat hole 306 and a lower seat hole 307 extending through the valve seat 104 from the inner seat surface 133 to the outer seat surface 333. The upper seat hole 306 can be disposed opposite from the lower seat hole 307. The upper seat hole 306 can be configured to seal against an upper journal 314 of the upper shaft 212 to prevent fluid from entering the upper neck 108 from the bore 131. The lower seat hole 307 can be configured to seal against a lower journal 313 of the lower shaft 312 to prevent fluid from entering the lower neck 118 from the bore 131.

The upper neck 108 can define an upper bore 340 extending through the upper neck 108 from the mounting surface 210 to the inner body surface 328. The upper bore 340 can be configured to receive the upper shaft 212. The upper shaft 212 can comprise a first end 318 and a second end 319 distal from the first end 318. With the upper shaft 212 inserted into the upper bore 340 of the upper neck 108 in an installed position, the first end 318 can extend radially inwards through the body 102 and into the bore 131 to engage the disc 106, and the second end 319 can extend through the top flange 110 and away from the mounting surface 210.

The first end 318 and the second end 319 can each define a profiled portion 316a,b, respectively. The profiled portion 316a of the first end 318 can be configured to engage an upper disc bore 341 defined by the upper shaft receiving portion 136 to prevent rotation between the disc 106 and the upper shaft 212. The profiled portion 316b of the second end 319 can be configured to engage a complimentary bore to prevent rotation between the upper shaft 212 and the complimentary bore. The complimentary bore to the second end 319 can be defined by the actuator 134, a lever, or a handwheel. With the first end 318 engaging the upper disc bore 341 and the second end 319 engaging the actuator 134, the upper shaft 212 can transmit the torque, for example, from the actuator 134 to the disc 106. The profiled portions 316a,b can each define a non-round cross-section such as a square, hexagonal, or triangular cross-section. In other aspects, the profiled portions 316a,b can each define a rounded profile with a flat machined into the upper shaft 212. In other aspects, the profiled portions 316a,b can each define splines. In other aspects, the profiled portions 316a,b can define each a keyway configured to receive a key. In some aspects, the profiled portions 316a,b can differ from one another in profile, cross-section, shape, or form.

The valve 101 can comprise an upper bushing 320 which can be tubular in shape. The upper bushing 320 can define an upper bushing bore 321. The upper bushing 320 can be installed in the upper bore 340 with the upper shaft 212 positioned within the upper bushing bore 321. The upper bushing 320 can be configured to protect against friction, corrosion, and impacts. The upper bushing 320 can be constructed from a nylon plastic or other suitable material such as NYLATRON. The valve 101 can also comprise a V-type packing ring 322 and an O-ring 323 disposed in the upper neck 108 to prevent leakage from the bore 131 through the upper neck 108. The V-type packing ring 322 can form a seal between the upper shaft 212 and the upper bore 340. The mounting surface 210 can define a recess 324 for receiving the O-ring 323. The O-ring 323 can provide a seal between the top flange 110 and the actuator 134. The top flange 110 can also define a plurality of mounting holes 310 configured for securing the actuator 134 in place.

The lower neck 118 can define a lower bore 342 extending through the inner body surface 328. The lower bore 342 can be disposed opposite from the upper bore 340, and the upper bore 340 and the lower bore 342 can be coaxial relative to the shaft axis. The lower shaft 312 can comprise a first end 360 and a second end 361 disposed opposite from the first end 360. With the lower shaft 312 installed in the lower bore 342, the first end 360 extends through the body 102 towards the bore 131. The first end 360 of the lower shaft 312 can be received in a bore (not shown) defined by the lower shaft receiving portion 138 of the disc 106.

The valve 101 can comprise a lower bushing 364 which can be tubular in shape. The lower bushing 364 can define a lower bushing bore 365. The lower bushing 364 can be installed in the lower neck 118 with the lower shaft 312 positioned within the lower bushing bore 365. The lower bushing 364 can be configured to protect against friction, corrosion, and impacts. The lower bushing 364 can be constructed from a nylon plastic or other suitable material such as NYLATRON. The valve 101 can further comprise a ball bearing 366 configured to reduce friction when the lower shaft 312 rotates. The ball bearing 366 can also be configured to resist a thrust load exerted on the lower shaft 312 by the disc 106. The ball bearing 366 can be disposed in the lower neck 118 proximate the bottom cap 120. The valve 101 can comprise an O-ring 367 disposed between the lower neck 118 and the bottom cap 120 to form a seal and prevent fluid from passing through the lower neck 118 or debris from entering the body 102. The bottom cap 120 can define a raised face portion 368 to improve the quality of the seal between the lower neck 118 and the bottom cap 120. In the present aspect, the bottom cap 120 can attach to the lower neck 118 with a plurality of fasteners 350; however, in other aspects, the bottom cap 120 can attach to the lower neck 118 with a different mechanism such as complimentary threaded portions defined by the lower neck 118 and the bottom cap 120.

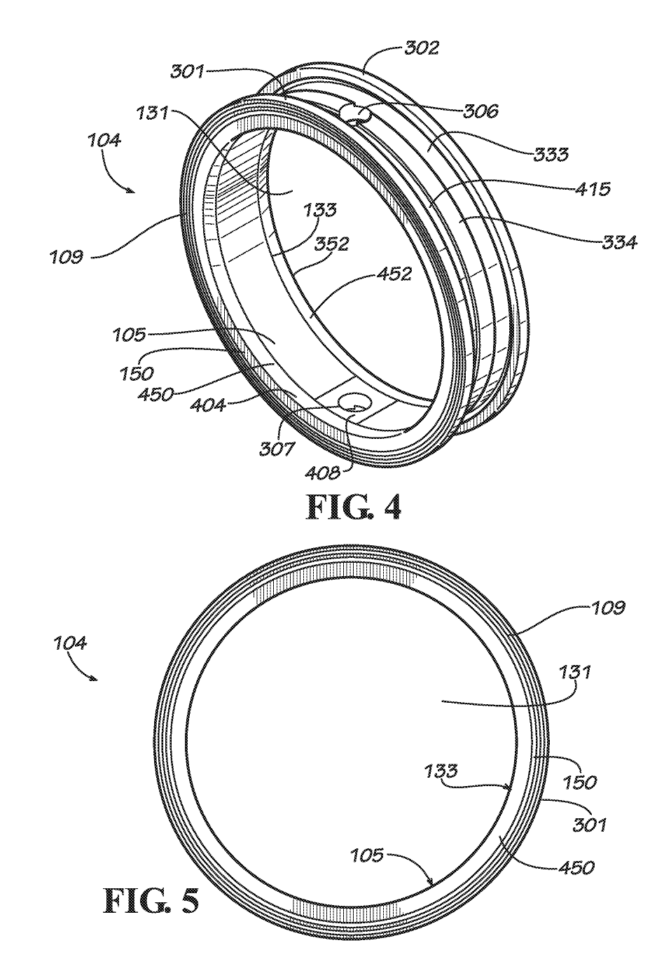

FIG. 4 shows a perspective view of the valve seat 104, and FIG. 5 shows a front view of the valve seat 104 facing the first seat end 150. In this aspect, the inner seat surface 133 can define the annular sealing surface 105, a first bevel 450, and a second bevel 452. The annular sealing surface 105 can be disposed between the first bevel 450 and the second bevel 452. The first bevel 450 can be disposed at the first seat end 150, and the second bevel 452 can be disposed at the second seat end 352. The first bevel 450 can provide a transition surface between the first flange sealing surface 109 and the annular sealing surface 105. The second bevel 452 can provide a transition surface between the second flange sealing surface 609 (shown in FIG. 6) of the second seat end 352 and the annular sealing surface 105. In some aspects, the transition surfaces can be rounded instead of beveled. The annular sealing surface 105 can define a pair of flat surfaces 408 surrounding the lower seat hole 307 and the upper seat hole 306. The flat surfaces 408 can be configured to reduce interference and friction between the disc 106 and the valve seat 104 when the disc 106 rotates.

The outer seat surface 333 of the valve seat 104 can define a central channel 415 between the first lip 301 and the second lip 302. The seat tongue 334 can be disposed in the central channel 415. The outer seat surface 333 can be shaped complimentary to the inner body surface 328. In some aspects, the valve seat 104 can comprise the annular sealing surface 105 and a seat body 404. The annular sealing surface 105 can be defined by the seat body 404.

FIG. 6 shows a cross-sectional view of the valve 101 taken from the line 6-6 of FIG. 2 facing downwards with the bore 131 approximately bisected and also shows the disc 106 in two different positions. In this aspect, the first body face 304 and the second body face 604 can each define a body shoulder 620a,b which are configured to interlock with a pair of seat shoulders 610a,b defined by the lips 301,302 of the valve seat 104. The body shoulder 620a can be defined by the first body face 304, and the body shoulder 620a can be configured to interlock with the seat shoulder 610a defined by the first lip 301. The body shoulder 620b can be defined by the second body face 604, and the body shoulder 620b can be configured to interlock with the seat shoulder 610b defined by the second lip 302.

The interlocking shoulders 610a,610b,620a,620b can secure the valve seat 104 in the body 102, particularly when the flange sealing surfaces 109,609 of the lips 301,302 are compressed against the pair of pipe flanges when the valve 101 is installed between pipes. The interlocking shoulders 610a,610b,620a,620b can protect against deformation and distortion of the valve seat 104 under friction from the disc 106 when seating and unseating the disc 106 in the closed position.

FIG. 6 shows the disc 106 is in a seated position 602 and an unseated position 603. The seated position 602 can be the same as the closed position. A travel path 601 for the disc 106 is superimposed over the cross-section of the valve 101. The travel path 601 shows a path of an outermost portion of the perimeter 207 of the disc 106 defined furthest from the shaft axis (not shown). As demonstrated by the overlap between travel path 601 and the valve seat 104, the perimeter 207 of the disc 106 can interfere with the annular sealing surface 105. In the seated position 602, the disc 106 can deform the annular sealing surface 105 of the valve seat 104 and press into the seat body 404. This deformation produces a normal force exerted between the annular sealing surface 105 and the perimeter 207 which creates the seal between the disc 106 and valve seat 104. The normal force results in a friction force acting on the perimeter 207 of the disc 106 which can resist rotation of the disc 106 relative to the valve seat 104.

In the aspect shown, the gap 674 defined between the seat tongue 334 and the groove 335 can provide clearance for the seat body 404 to deform to fill the gap 674 when the disc 106 is in the seated position 602. In these embodiments, the seat body 404 can deform more easily which can reduce the normal force and the force of friction between the annular sealing surface 105 and the perimeter 207 of the disc 106 which can reduce the torque needed to seat or unseat the disc 106. In some aspects, the gap 674 can be annular and extend completely around the valve seat 104.

Disc 106 is also shown superimposed in the unseated position 603. As shown by the travel path 601, rotating the disc 106 to the unseated position 603 can withdraw the perimeter 207 from contact with the annular sealing surface 105. The perimeter 207 of disc 106 in the unseated position 603 can be positioned at an edge of the bevels 450,452. Further rotation in the counter-clockwise direction can break contact between the perimeter 207 and the valve seat 104. As the perimeter 207 withdraws from the annular sealing surface 105, the deformation of the annular sealing surface 105 is reduced, and both the normal force and the friction force exerted between the disc 106 and the valve seat 104 are reduced. In the present aspect, the disc 106 can be rotated counter-clockwise to unseat the disc 106 from the annular sealing surface 105. In other aspects, rotating the disc 106 clockwise can unseat the disc from the annular sealing surface 105. In some aspects, the disc 106 can be rotated either clockwise or counter-clockwise to unseat the disc 106 from the annular sealing surface 105.

During operation, the torque can be transmitted from the actuator 134 through the upper shaft 212 to the disc 106 in order to rotate the disc 106. The torque required to rotated the disc 106 can depend upon the position of the disc 106. The torque required by the actuator 134 to rotate the disc 106 can reach a maximum value when unseating the disc 106 from the closed position. The maximum value can occur during the first few degrees of rotation when unseating the disc 106 from the annular sealing surface 105. If left in the closed position for an extended period of time, the valve seat 104 can take a temporary set from the deformation. The temporary set can further increase the torque required to unseat the disc 106 from the valve seat 104.

The torque required to unseat the disc 106 can increase as a diameter of the bore 131 and a diameter of the disc 106 increases. The torque can be defined by the force of friction multiplied by a lever arm. The lever arm can be defined as a radial distance between the perimeter 207 and the shaft axis about which the disc 106 can rotate. As the diameter of the disc 106 increases, the lever arm of the torque increases which can increase a value of the torque required to rotate the disc 106. Additionally, as the diameter of the disc 106 increases, a contact surface between the annular sealing surface 105 and the perimeter 207 of the disc 106 can increase which can increase the normal force and the friction force exerted upon the disc 106.

In the present aspect, when moving the disc 106 to the seated position 602, the disc can be rotated in the clockwise direction to seat the disc 106 against the valve seat 104. At the angle shown in the unseated position 603, disc 106 is in light contact with the valve seat 104 without deforming the annular sealing surface 105. Further rotating the disc 106 to the seated position 602 can deform the annular sealing surface 105 and form the seal between the perimeter 207 of the disc 106 and the annular sealing surface 105. Deformation during seating also produces the normal force and the frictional force between the disc 106 and the valve seat 104 during seating of the disc 106. The torque required to seat the disc 106 can be less than the torque required to unseat the disc 106; however, in other aspects, the torque required to seat the disc 106 can be greater or equal to the torque required to unseat the disc 106.

The torque required to activate the valve 101 can determine both the size and gearing required for the actuator 134. Large peak torque values can require excessively large and heavy actuators 134, or excessive power consumption for automated actuators 134. Manual actuators 134 can require large torque multiplication values which require more rotations of the handwheel 124 to actuate the valve between the open position and the closed position. In some applications, opening the valve 101 by hand can be time consuming and exhausting due to the deep gear ratios required by the actuator 134. Because the peak torque value only occurs over a few degrees of rotation when seating and unseating the disc 106 in the closed position, reducing the friction between the disc 106 and the valve seat 104 can allow a smaller actuator to be used for a given application.

In the present aspect, the valve seat 104 can comprise a rubber-lubricant mixture. In some aspects, only the annular sealing surface 105 can comprise the rubber-lubricant mixture, and the rubber-lubricant mixture may only be disposed in the seat body 404 beneath the annular sealing surface 105 of the valve seat 104 to at least a specified depth. In other aspects, the entire seat body 404 of the valve seat 104 can comprise the rubber-lubricant mixture. In some of these aspects, the valve seat 104 can be homogenous throughout the entire seat body 404. The rubber-lubricant mixture can be configured to reduce the friction between the valve element 103 and the valve seat 104 as well as the peak torque values required to seat and unseat the valve element 103 from the valve seat 104. The rubber can be ethylene propylene diene monomer (“EPDM”) rubber; however, in other aspects, the rubber can be a different rubber formulation such as Buna-N, neoprene, nitrile, Viton, silicone rubber or other rubber formulations. In some aspects, the rubber can be a natural rubber, a polymer, or an elastomer. The lubricant can be an amide derivative such as LUBE-2; however, in other aspects, the lubricant can be a different formulation such as a silicone-based lubricant, an oil, or other lubricant formulations. The amide derivatives can comprise organic amides, carboxamides, phosphoramides, sulfonamides, acetamides, or any other suitable amide derivative. Some amide derivatives, such as acid amines, can be formed by reacting an acid, such as carboxylic acid, benzoic acid, succinic, or any other acid, with an amine, such as an alkylamine, an arylamine, or any other amine. In some aspects, the rubber-lubricant mixture of the seat body can comprise a concentration of lubricant of about 12 Parts per Hundred Rubber (“PHR”). In some aspects, the rubber-lubricant mixture of the seat body can comprise a concentration of lubricant between 30 g/kg and 60 g/kg (measured in grams of lubricant/kg of rubber compound, including additives). In some aspects, the rubber-lubricant mixture of the seat body can comprise a concentration of lubricant between 45 g/kg and 55 g/kg. In some aspects, the rubber-lubricant mixture of the seat body can comprise a concentration of lubricant of about 50 g/kg.

The valve seat 104 can be formed by mixing a raw rubber with the lubricant to form the rubber-lubricant mixture. The rubber-lubricant mixture can then be placed, such as by pouring or injecting, into a mold. The rubber-lubricant mixture can then be cured through a process such as vulcanization; however, in some aspects other processes can be used. The valve seat 104 can then be removed from the mold and thereafter installed in the valve assembly 100. The mold can define a mold cavity which can be shaped and sized complimentary to the valve seat 104. When the rubber-lubricant mixture is placed into the mold, the rubber-lubricant mixture can fill the mold cavity and take a shape of the valve seat 104. Upon curing the rubber-lubricant mixture, the rubber-lubricant mixture can solidify and the valve seat 104 can be removed from the mold cavity.

LUBE-2 is a lubricant manufactured by Longsun Chemical, headquartered in Shanghai, China. LUBE-2 is an amide derivative with a melting point of 72° C.-77° C. LUBE-2 is available as a white powder or granular compound with a purity greater than or equal to 98%. LUBE-2 is used in some applications where National Sanitation Foundation (NSF) certification is required such as the manufacture of food packaging, and can be acceptable for such applications. In applications where NSF certification is unnecessary, a silicone-based additive can be used.

During testing, valve seats for a Pratt 8″ wafer-type BF series butterfly valve were formed comprising a rubber-lubricant mixture. LUBE-2 lubricant was added and mixed with EPDM rubber prior to vulcanizing the rubber and forming the valve seats. Rubber samples were formed comprising varying concentrations of LUBE-2 ranging from 30 g/kg to 100 g/kg, and the rubber samples were assessed based on their appearance, texture, and quality. At 100 g/kg, the rubber samples exhibited an undesirable sticky texture. Rubber samples formed with concentrations of 75 g/kg and 60 g/kg visually appeared oily. Rubber samples formed at 50 g/kg were acceptable in appearance, texture, and rubber quality. Rubber samples formed with a concentration of 30 g/kg visually appeared dry and rough.

Once a concentration providing desirable qualities was determined from the test results, a valve seat was formed with a concentration of 50 g/kg for further testing. A Pratt 8″ wafer-type BF series butterfly valve was assembled without stem seals in order to test the seal quality of the prototype 50 g/kg valve seat. The valve was installed between a pair of pipe flanges tensioned to 1,000 psi. A leak test was performed with 275 psi on one side of the valve and atmospheric pressure on the opposite side of the valve. 275 psi represents approximately 120% of the specified design pressure for the valve, 230 psi. This test pressure exceeds typical leak test requirements which are typically performed at 110% of the specified design pressure rating. The pressure was held while the valve was monitored for leaks or pressure changes. The leak test was conducted for 45 minutes which exceeds the typical 5 minute leak test period. The prototype 50 g/kg valve seat successfully passed the test while demonstrating a bubble tight seal with the disc and stem journals during the test period.

The valve was additionally hydrotested at 460 psi, 200% of the design pressure for the valve. The valve was tested in the open position. The valve successfully passed the hydrotest without issue.

An actuation torque-test was also performed on the valve. The published peak actuation torque for the Pratt 8″ wafer-type BF butterfly valve is 1,795 in-lbs. When testing the valve with the prototype 50 g/kg valve seat, the measured peak torque value averaged 780 in-lbs over multiple test cycles. The results demonstrate over a 50% decrease in torque from the published peak torque values. A second Pratt 8″ wafer-type butterfly valve was assembled with a 50 g/kg prototype valve and test. Torque testing of the second valve provided similar results.

The experimentation revealed that concentrations from 30 g/kg to 60 g/kg are possibly acceptable, and the preferred concentration range is 45 g/kg to 55 g/kg with an optimum value of 50 g/kg. The concentration of 50 g/kg is approximately equivalent to 12 PHR (per hundred rubber) for the tested formulation. The concentrations provided can be reliable for the specific formulations tested; however, the concentrations should also be acceptable for lubricants similar to LUBE-2, or other amide derivatives as well. The concentrations can also be useful for other lubricants, and concentrations outside of the provide concentrations ranges may be used, for example, if other lubricants are mixed with the rubber.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A valve seat comprising:
an annular sealing surface comprising a rubber-lubricant mixture; and
a seat body.

2. The valve seat of claim 1, wherein the seat body defines the annular sealing surface and comprises the rubber-lubricant mixture.

3. The valve seat of claim 1, wherein the rubber-lubricant mixture comprises an amide derivative.

4. The valve seat of claim 1, wherein the rubber-lubricant mixture comprises LUBE-2.

5. The valve seat of claim 1, wherein the rubber-lubricant mixture comprises a concentration of lubricant between 30 g/kg and 60 g/kg.

6. The valve seat of claim 1, wherein the rubber-lubricant mixture comprises a concentration of lubricant measured in g of lubricant/kg of rubber between 45 g/kg and 55 g/kg, inclusive.

7. The valve seat of claim 1, wherein the rubber-lubricant mixture comprises a concentration of lubricant of about 50 g of lubricant per kg of rubber.

8. The valve seat of claim 1, wherein the valve seat is configured as a butterfly valve seat.

9. A valve comprising:
a valve body;
a valve element disposed within the valve body; and
a valve seat comprising a rubber-lubricant mixture, the valve element configured to seal against the valve seat.

10. The valve of claim 9, wherein the valve is a butterfly valve and the valve element is a disc, wherein the butterfly valve defines a bore with a diameter greater than or equal to 8 inches, and wherein the disc is configured to seal against the valve seat with a torque of less than or equal to 800 IN-LBS.

11. The valve of claim 9, wherein the rubber-lubricant mixture defines a sealing surface of the valve seat, and wherein the valve element is configured to seal against the sealing surface of the rubber-lubricant mixture.

12. The valve of claim 9, wherein the valve seat is mounted between the valve element and the valve body.

13. The valve of claim 9, wherein the rubber-lubricant mixture comprises an amide derivative.

14. The valve of claim 9, wherein the rubber-lubricant mixture comprises LUBE-2.

15. The valve of claim 9, wherein the rubber-lubricant mixture comprises a concentration of lubricant measured in g of lubricant/kg of rubber between 45 g/kg and 55 g/kg, inclusive.

16. The valve of claim 9, wherein:
the valve body defines a groove;
the valve seat defines a tongue extending into the groove; and
a gap is defined between the tongue and the groove.

17. A method for forming a valve seat comprising:
mixing a raw rubber with a lubricant to form a rubber-lubricant mixture;
placing the rubber-lubricant mixture into a mold configured to form a valve seat; and
curing the rubber-lubricant mixture.

18. The valve of claim 17, wherein the lubricant is an amide derivative.

19. The valve of claim 17, wherein the lubricant is LUBE-2.

20. The valve of claim 17, wherein a concentration of the rubber-lubricant mixture is between 45 g of lubricant/kg of rubber and 55 g of lubricant/kg rubber, inclusive.
